(19) United States
(12) Patent Application Publication
(10) Pub. No.: US 2001/0054084 A1
(43) Pub. Date: Dec. 20, 2001

(54) Method and system for communication in the usenet

(76) Inventor: Arkadi Kosmynin, Brunswick (AU)

Correspondence Address: SUGHRUE, MION, ZINN, MACPEAK & SEAS, 2100 Pennsylvania Avenue, N.W., Washington, DC, 20037-3202, US

(21) Appl. No.: 09/725,312

(22) Filed: Nov. 29, 2000

(30) Foreign Application Priority Data
Dec. 31, 1999 (AU) PQ4924
Aug. 11, 2000 (AU) PQ9344

(51) Int. Cl. G06F 15/16

(52) U.S. Cl. 709/218; 709/203

(57) ABSTRACT

The present invention relates to Internet information services. In particular, the present invention relates to improvements related to and/or use of the Usenet. The present invention also has application to email systems, as well as other electronic distribution media.

In one aspect, the present invention relates to the distribution, access and/or download speed of Web objects, and involves a new system design and method of use, providing a Usenet based alternative to the current Web caching and mirroring solutions.

A second aspect of the present invention relates to a method that enables relatively transparent encoding within Web objects' URLs information necessary to locate the object in a Usenet server and retrieve it. The method also allows transparent retrieving of news cached objects from their original servers.

### FIELD OF THE INVENTION

The present invention relates to Internet information services. In particular, the present invention relates to improvements related to and/or use of the Usenet. The present invention also has application to email systems, as well as other electronic distribution media.

In one aspect, the present invention relates to the distribution, access and/or download speed and efficiency of relatively large binary objects, and involves a new system design and method of use.

In a second aspect of the present invention relates to a method that enables relatively transparent encoding within objects' URLs information necessary to locate the object in a Usenet server and retrieve it. The method also allows transparent retrieving of news cached objects from their original Web servers.

### BACKGROUND

The Usenet is a worldwide bulletin board system that can be accessed through the Internet or through many online services. The Usenet contains tens of thousands of forums, called newsgroups, that cover many and varied interest groups. The Usenet is used daily by millions of people around the world.

Every Usenet message belongs to a newsgroup. Messages are made available to users worldwide by means of the UUCP and NNTP protocols (Unix to Unix Copy Program, and Network News Transport Protocol, respectively). Individual computing sites appoint somebody to oversee the huge quantity of incoming messages, and to decide how long messages can be kept before they must be removed to make room for new ones. Typically, messages are stored for less than a week. They are made available via a news server.

Users access local newsgroups with a newsreader program. Modern WWW browsers come with a built-in newsreader. A dedicated newsreader program can also be used. The newsreader accesses the local (or remote) News host using the Network News Transfer Protocol (NNTP), enabling a user to pull down as many newsgroups and their contents as they desire. If there is no local access to News, there are publicly accessible commercial and free Usenet hosts that can be accessed.

Users sending Usenet messages must address each message to a particular newsgroup. There are newsgroups on subjects ranging from education for the disabled to Star Trek and from environment science to politics in the former Soviet Union. The quality of the discussion in newsgroups may be excellent, but this is not guaranteed. Some newsgroups have a moderator who scans the messages for the group and decides which ones are appropriate for distribution.

Some of the newsgroups provide a useful source of information and help on technical topics. Users needing to find out about a subject often send questions to the appropriate newsgroup, and an expert somewhere in the world can often provide an answer. Lists of Frequently Asked Questions are compiled and made available periodically in some newsgroups.

The transmission of Usenet news is cooperative. There are places which provide feeds for a fee (e.g. UUNET), but the majority of news transmission is carried out on the basis of peer agreements.

There are two major transport methods, UUCP and NNTP, as previously noted. The first is mainly modem based and involves the normal charges for telephone calls. The second, NNTP, is the most used method for distributing news over the Internet.

With UUCP, news is stored in batches on a site until the neighbor calls to receive the articles, or the feed site happens to call. A list of groups which the neighbor wishes to receive is maintained on the feed site. The Cnews system compresses its batches, which can dramatically reduce the transmission time necessary for a relatively heavy newsfeed.

NNTP, on the other hand, offers a little more latitude with how news is sent. The traditional store-and-forward method (as noted above) is, of course, available. Given the “real-time” nature of the Internet, though, other methods have been devised. Programs now keep constant connections with their news neighbors, sending news nearly instantaneously, and handle dozens of simultaneous feeds, both incoming and outgoing.

The transmission of a Usenet article is centered around the unique ‘Message-ID:’ header. When an NNTP site offers an article to a neighbor, it says it has that specific Message ID. If the neighbor finds it hasn't received the article yet, it tells the feed to send it through; this is repeated for each and every article that is waiting for the neighbor. Using unique IDs helps prevent a system from receiving multiple copies of an article from each of its many news neighbors, for example.

The Usenet was originally designed for exchange of textual information, but presently the major part of bandwidth and storage resources is consumed by so called “binary” newsgroups that mainly carry binary data. In terms of bytes, the top four newsgroups consume 22% of the entire volume. The top 35 groups consume 50% of the entire volume.

In relation to the first aspect, many Internet Service Providers do not service a lot of the binary groups because these binary groups are considered to send the total volume of news soaring. The total news feed is said to be about 25 to 30 Gb a day.

If otherwise normal text groups get relatively large volumes of binary objects posted, there is a danger that ISPs will drop them from their news feeds. To address this, there are approved cancel ‘bots’ that remove all messages containing large binary objects from the main news groups. It is the action of those people who cancel and the restraint of the majority of users that helps to keep the newsgroups alive.

The average text message is probably about 2K or less in size (unless it also contains HTML) but a binary object can easily run from 20K to 250K and more. For many groups a single binary object can equal the entire day's text download.

News articles are stored in news servers to enable users to access them. But this storage brings about another problem, that being the limited availability of storage space. To limit amount of disk space occupied by binary newsgroups, ISPs normally set shorter expiration time limit for binary postings. This helps to save disk space in short term, but users of popular binary news groups compensate for this by re-posting popular binary objects regularly, to ensure their availability. This reduces the effect of the measures taken by ISPs and even makes the situation worse because:

1) Often a binary object is re-posted by more then one poster and this results in there being several copies of the binary object stored on the server attached to different messages, and

2) Regular re-posting of large binary objects is considered to lead to a waste of bandwidth that should be avoided.

Another problem is being caused by a violation of the Usenet etiquette by some posters. Because they want as many people as possible to see their messages, they send the messages to many newsgroups. In extreme cases, they send messages to newsgroups that are hardly related to the topic.

A major part of storage and traffic resources is spent because all messages, including binary objects, have to be sent and stored in textual format. There is no compression for textual messages, and binary objects have to be text-encoded. This does not decrease their size. Quite the opposite, this increases their size by 33%.

Some attempts have been made in the past to address these problems, but with limited success.

As described above, some ISPs try to reduce expenses caused by handling binary attachments by setting low limit on time that a message with a binary object will spend in the news pool on their server. However, this is not considered an effective solution because often the same binary object returns re-posted with a new message. This increases news feed traffic and leads to multiple copies of the same object being stored.

News server software that uses UUCP for news feeding (such as the Cnews program) compresses sets of news messages before transferring them. Compression allows for a reduction in bandwidth requirements, but most of binary data (e.g. images and video) is hard to compress without a loss of quality. This means that compression is considered useful when applied to textual data, but not considered useful when applied to most kinds of binary data.

News caching is a popular approach. It has been implemented in Dnews software. This method does not download news messages until a user shows interest in the newsgroup. Once a user has subscribed to a newsgroup, the whole newsgroup is downloaded. This method does not avoid problems associated with duplication of binary objects. Also, if the number of users is considerably large, this method is unlikely to provide a significant advantage because most of the newsgroup contents end up being downloaded.

There does exist some patent literature related to the problem of storage and exchange of information in an electronic environment, but these disclosures are also not considered to solve the problem(s) noted above. In particular, there is:

U.S. Pat. No. 5,771,355—Title: Transmitting Electronic Mail by Either Reference or Value at File-Replication Points to Minimise Costs. This patent covers technology aimed at improving e-mail delivery in certain conditions. E-mail attachments are delivered by “optimal path”. For example, when the path includes intermediary points that make it much longer than the distance from the sender to the receiver, it makes sense to defer sending of attachment until the receiver requests it and, in this case, send attachment directly from the site where it is stored to the receiver.

However, the disclosure does not appear to address the Usenet, nor the duplication problem noted above. Addressing the problem of finding equivalent objects attached to different messages and posted by different users also does not appear to be disclosed.

U.S. Pat. No. 5,903,723—Title: Method and Apparatus for Transmitting Electronic Mail Attachments with Attachment References. The disclosure relates to a modified version of the patent discussed above, but it too does not appear to address the issues noted above.

U.S. Pat. No. 5,813,008—Title: Single Instance Storage of Information. This patent relates to avoiding storing multiple copies of ‘common portions’ of information records on a network of storage devices. The disclosure, however, does not relate to the Usenet, but to email. In the email system disclosed, when a user's mailbox is moved to a new server, the single-instance identifiers of the messages in the moved mailbox are compared to a table of single-instance identifiers associated with messages already stored on the new server. Copies are made of only the common portions for which a copy is not already stored on the new server. From this it can be seen that the disclosure relates to avoiding storing multiple copies within a single server, not within the network as a whole. Otherwise they would not have to make copies “of only the common portions for which a copy is not already stored on the new server.”

The disclosed method for finding common portions finds only common portions created as a result of modifying the same information item (e.g. e-mail message). In other words, the common portions are inherited by the items from a common ancestor. However, this does not address problems associated with finding attachments posted by different users independently, and thus, not having any common ancestors that could be traced.

U.S. Pat. No. 5,815,663—Title: Distributed Posting System Using an Indirect Reference Protocol. This patent disclosure describes posting marked up messages to news groups. In this system, a message would look like an HTML page with various elements (like images) and links to other pages or messages. The patent describes two ways to give access to the page elements. The first one is to send them with the message as attachments. The second one is to provide URL-like references to the elements.

Again, this patent disclosure is not considered to address the problem with attachments posted by different users independently, or even avoiding storing same objects posted as attachments by the same user.

U.S. Pat. No. 5,815,663—Title: Method and Apparatus for Identifying Duplicate Data Messages in a Communication System. This patent disclosure is considered directed at how to determine whether one message is a copy of another message in an environment where errors are very frequent. In the Usenet, however, the environment is relatively error free, and thus the problems addressed in this disclosure are not considered relevant to the problems of the present invention.

Publication No 05316143 (Japanese)—Title: Electronic Mail Processor and Method Therefor. In this disclosure, instead of sending an e-mail message to all destination mailboxes, it is suggested to send only its id and to keep the message in a central repository until requested. Again, it appears unrelated to the Usenet.

Given large average size of binary objects, pollution of binary newsgroups by spam and slow speed of downloading via modem lines, it is very important to help users to make better decisions on whether to download a particular binary object. Because, if this decision is wrong, they spend resources (their own time, on-line time, traffic) on downloading an object that they will discard right after downloading and examining.

In a decentralised, anarchic system, like Usenet, it is important to provide people with better means of orientation, filtering spam and selection of quality items. Some attempts have been made in the past to address the problem, but with limited success.

Currently, almost the only description of an article is its subject. This way of describing information items is more or less adequate for textual messages that contain text discussing the subject. For multimedia items, one-line descriptions can hardly be adequate. Normally, subject contains name of the collection or short description of the multimedia item, name of file, number of the part and total number of parts (such as “Persian kitten cats123.jpg (1/1) 35567 bytes”). This format is often used, but many multimedia postings do not have even that. Often subject lines are quite meaningless, e.g. “My loved kittens”.

A still further problem is the relatively large amount of traffic and relatively slow response times over the Internet. Users feel frustrated if they have to wait a long time for a response from their Web browser. A relatively fast response has become absolutely critical for emerging multibillion e-commerce business. Research shows that a substantial part of users, if idle for more than 8 seconds, would exit a site without completing the transaction. Estimated $4.8 billion is lost annually due to such bail-out behaviour.

Latency time is an effect of delays caused by a number of reasons, such as there being a: large number of objects to retrieve in order to construct the page, speed of light delays, connection delays, router delays, server delays and transmission delays.

Caching is a cheaper alternative to increasing connection bandwidth. The idea of caching is to move the objects, likely to be requested, closer to the consumer.

One popular approach to improving the Web performance is to deploy proxy cache servers between clients and content servers. With proxy caching, most of the client requests can be serviced by the proxy caches, thus reducing latency delays. Network traffic on the Internet can also be significantly reduced, eliminating network congestion. In fact, many commercial companies are providing hardware and software products and solutions for Web caching, such as Inktomy, Network Appliance and Akamai Technologies. Some of them are using geographically distributed data centers for collaborative Web caching. Namely, many geographically distributed proxies are increasingly used to cooperate in Web caching.

Analysis of Internet traffic shows that transmission of objects bigger than 1 Mb in size takes about 40% of the total Internet traffic, which is a significant amount, considering that less than 1% of transmitted objects is this size. According to the same source, transfer error rate increases exponentially as the object size becomes larger than 10 Mb and the error rate of objects larger than 10 Mb is over 80%. This data shows that, first, large objects constitute a significant amount of Internet traffic. Thus, we can conservatively estimate that objects larger than 100K in size take at least 70% (or more) of the traffic. Second, this data shows that large objects are very hard to download, not only because it is slow, but also because the process of downloading a large object is more likely to fail. This is thus considered an obstacle to the use of large multimedia objects on the Web, for example, for e-commerce and remote education services.

It is an object of the present invention to alleviate at least one problem associated with the prior art.

The present invention seeks to offer a Usenet based solution to the caching of Web objects.

### SUMMARY OF INVENTION

### First Aspect

A first aspect of the present invention provides a method, system and/or network for transporting of Web objects from the server side (their original server) to the client side via the Usenet or a Usenet-like system. The method includes: Constructing/determining/allocating a URL (Uniform Resource Locator) for the object,

placing the object on the original server in such a way that this URL

a) contains information necessary to find the object in a Usenet server;

b) indicates that the object has been posted to the Usenet and may be found on a Usenet server; and

c) that the URL can be used to retrieve the object transparently from its original server.

Furthermore, the method may include:

posting the object on the Usenet;

on the client side, intercepting requests for the object, interpreting them and using the extracted information to find the object from a Usenet server and return it to the client.

1. A method of associating an URL with a Web object(s) for transport from a server side (their original server) to a client side via the Usenet or a Usenet-like system, the method including the steps of:

a. Constructing/determining/allocating a URL (Uniform Resource Locator) for the object, and

b. placing the object on the original server in such a way that this URL

1. contains information necessary to find the object in a Usenet server;

2. indicates that the object has been posted to the Usenet and may be found on a Usenet server; and

3. can be used to transparently retrieve the object from its original server.

This aspect also provides a method of transporting Web object(s) via a Usenet, the method including:

associating a URL with the Web object as outlined above,

posting the object on the Usenet;

at a client side, intercepting requests for the object, interpreting them and using information extracted, as a result of the interpretation, to retrieve the object from a Usenet server.

This aspect also provides a useful method of constructing an URL useful in accordance with the method as disclosed above.

Still further, the present aspect provides a communication system adapted to distribute Web objects from a web host server to a client, the system having:

a Web host sever on which the web objects are stored, the web host server being coupled to the WWW (World Wide Web),

the coupling between the client, the WWW and web host server enabling bi-directional communication,

The improvement including

providing a first Caching agent intermediate and coupled to the client and WWW and Usenet, and

providing a second Caching agent intermediate and coupled to the WWW and the Usenet and the web host server,

wherein the first and second Caching agents enable communication of objects between the client and the Web host server to be via either the Internet or the Usenet.

The Internet includes the WWW.

The advantage of this method and system is that the Usenet has all the necessary infrastructure and functionality to be used for distribution of objects from server side to client side. Usenet replication mechanisms ensure economic transmission of messages and replication of messages on servers that are subscribed to their newsgroup.

Thus, Usenet can be used for automatic replication and mirroring of Web objects. In context of this task, newsgroups can be seen as subscription channels to which servers subscribe if their users are likely to retrieve posted Web objects. One of the examples could be a “Shareware channel” that would be automatically mirroring contents of Web shareware servers on the Web.

Periodic re-posting of the objects would be required to ensure their availability in the Usenet servers, as, depending on the server's settings, most of the messages expire within a few days. In the context of old NNTP protocol, this periodic re-posting would be considered a gross waste of resources. However, if NNTP extensions disclosed in this application are also implemented, periodic re-posting of large binary objects would be reduced to transmitting small textual parts of the messages. Thus, periodic re-posting of objects, in fact, is reduced to posting messages that state that this object is current.

This aspect of invention allows the integration of the Usenet and the Web in order to use the Usenet as an economical distribution vehicle for Web objects. Usenet distribution of Web objects brings all the advantages of caching of Web resources: faster downloading for users, taking the load off the original servers, and saving the precious Internet bandwidth resources. In this regard, this first aspect, in one form, is directed to Usenet-based preemptive caching and relatively automatic mirroring of Web information objects. This uses Usenet protocols and existing infrastructure to replicate relatively large files/ binary objects normally stored on and served from Web servers, and moves these files closer to the likely consumers. Requests are serviced from there, thus avoiding relatively expensive transmission of large files from their original Web servers to remote consumers.

The process of delivery (distribution, replication, mirroring, caching) of large objects should be given importance because it is considered an effective way to reduce the traffic on the Internet. It is considered that the solution offered in this aspect would be a relatively simple and cheap alternative to traditional Web caching solutions available in the prior art. A review of the patent disclosures, research papers and methods and products developed by the leading companies in the area is considered to show that no one considers the Usenet a suitable vehicle for distribution of pre-cached Web objects.

### Second Aspect

A second aspect of the present invention provides a method of creating a URL for use in the Web, the method including the steps of:

providing a first field having information sufficient to locate an object on a web server, and

providing a second field having information sufficient to locate the object on the Usenet.

In essence, this aspect discloses a method that enables transparent encoding within objects' URLs information necessary to locate the object in a Usenet server and retrieve it. A number of example implementations are disclosed and any of these (as well as other methods as would be apparent to the skilled person) may be used in our system. These methods allow transparent retrieving of news cached objects from their original servers, in case if the objects could not be found in the Usenet or no Usenet server is available to the client.

Embodiments of the various aspects of the present invention will now be described with reference to the accompanying drawings, in which:

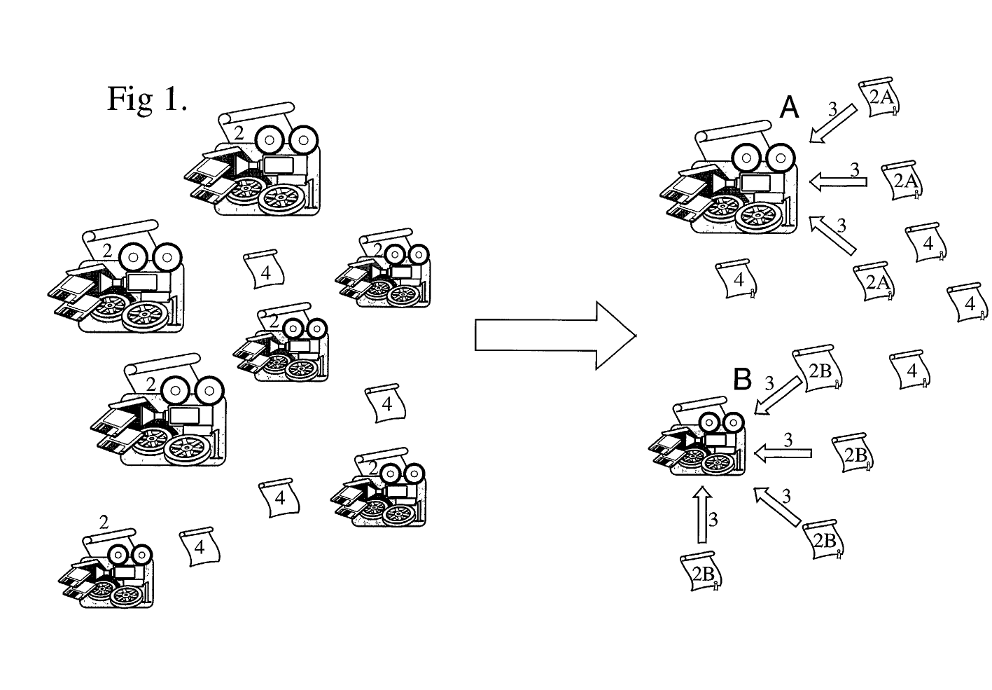

FIG. 1 illustrates schematically differences in storage of binary objects between the present system and the prior art.

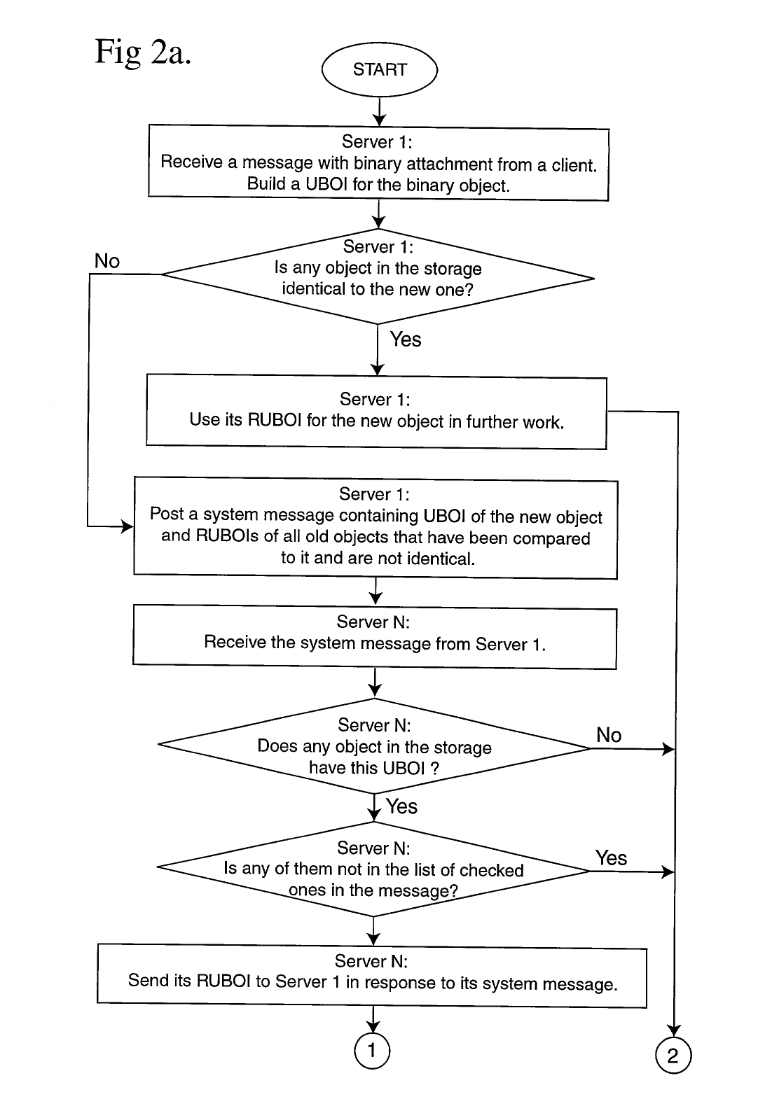

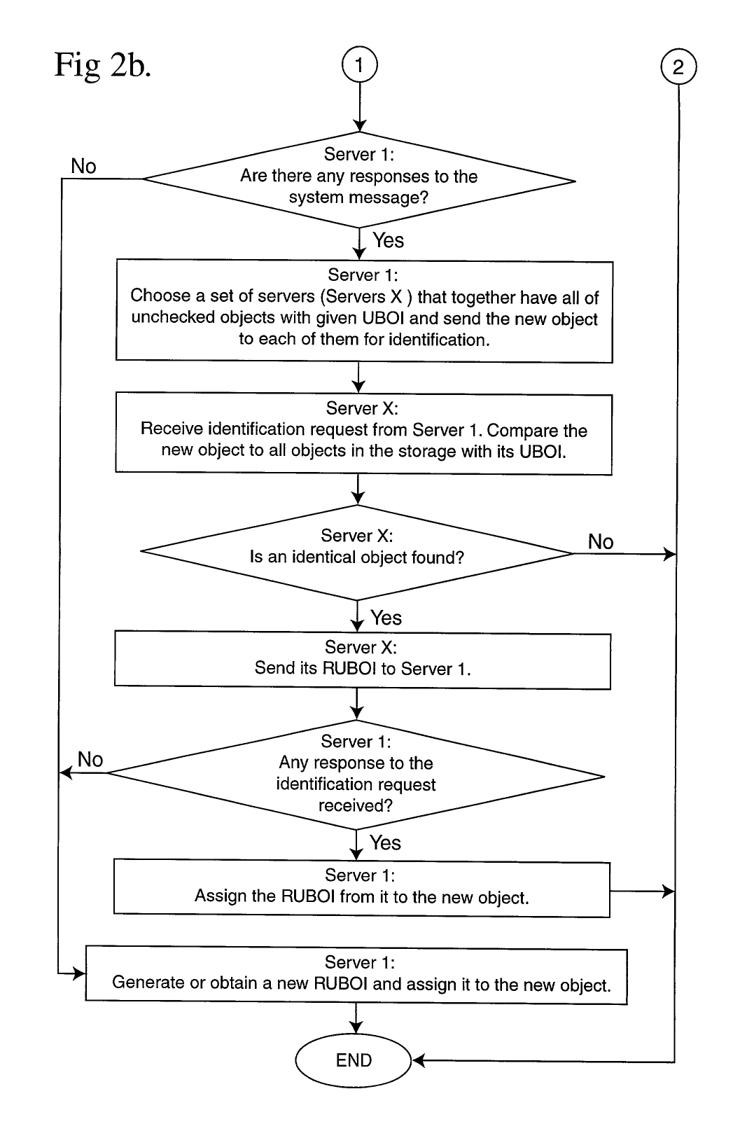

FIG. 2 illustrates schematically a 1^{st} method applicable to the present system that can be used to identify binary attachments.

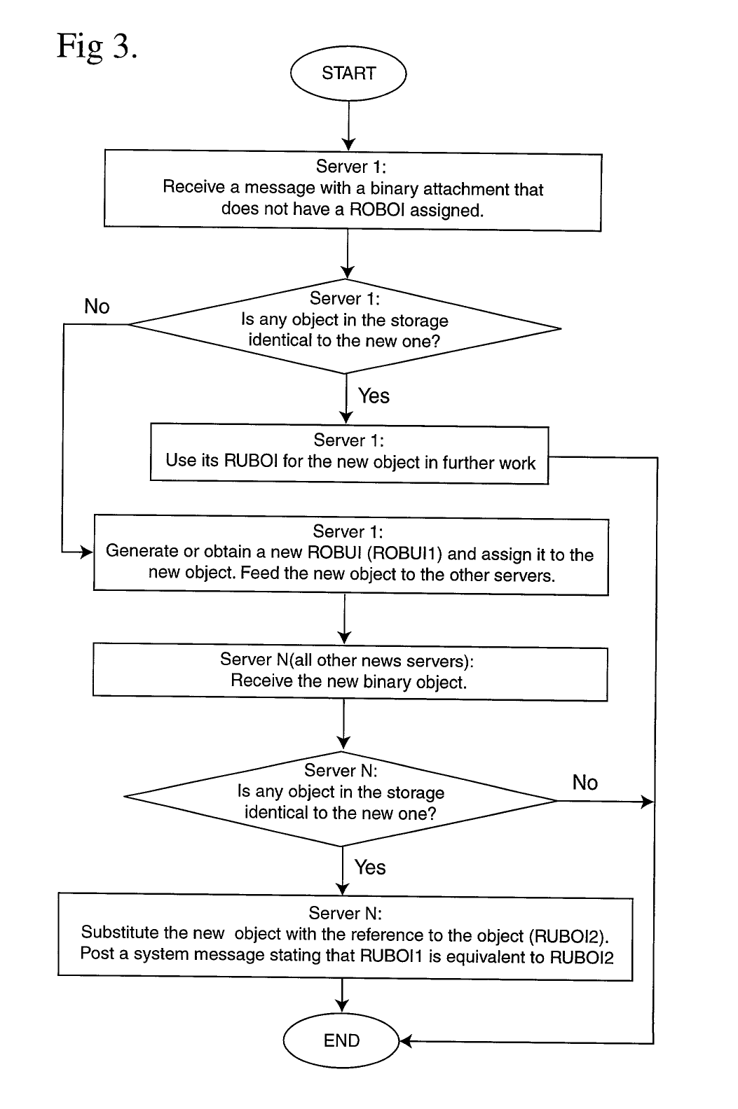

FIG. 3 illustrates schematically a 2^{nd} method applicable to the present system that can be used to identify binary attachments.

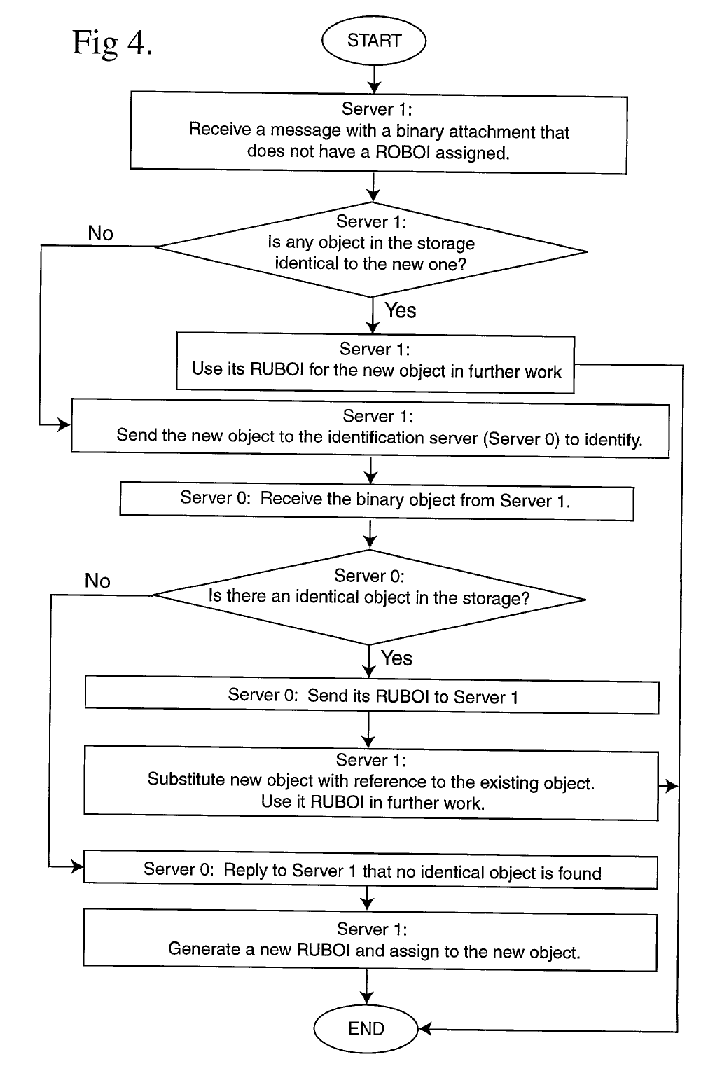

FIG. 4 illustrates schematically a 3^{rd} method applicable to the present system that can be used to identify binary attachments.

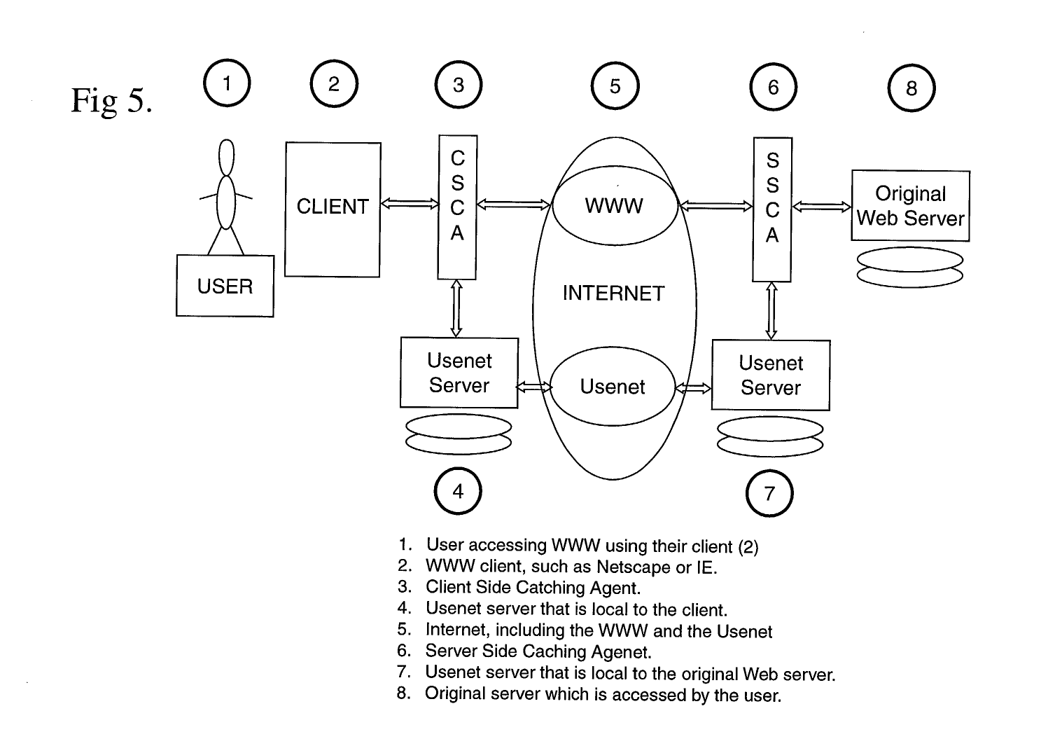

FIG. 5 illustrates schematically macro-architecture of the system implementing Usenet based caching that is the first aspect of our invention.

### A FIRST SYSTEM

### First Embodiment

In this embodiment, this invention can be implemented by changing the way news server stores messages in the database and introducing extended analogues of ARTICLE, BODY, IHAVE, NEWNEWS, and POST commands of the NNTP protocol. We will call them XARTICLE, XBODY, XIHAVE, XNEWNEWS and XPOST respectively.

This embodiment is not the only form in which the invention can be performed, and thus the invention should not be limited to the embodiment disclosed.

In terms of this invention, the server will store message bodies and binary attachments separately. Only a reference to the binary attachment will be stored with the message. On the other side, with each binary object an integer number will be stored with the value equal to the number of messages referring to this binary object. If this number is zero, no messages in the server's database have this object as a binary attachment and the object can be safely removed. However, it can be considered keeping “unattached” objects in the database for a while, just in case that they will be re-posted with a new message soon.

FIG. 1 illustrates transition from storing binary attachments 1 in messages 2 to storing binary attachments 1A, 1B, etc separately and providing references 3 from the corresponding messages 2A, 2B, etc to their corresponding binary attachments. There are two different binary attachments in the picture, each is shared among 3-4 messages. We need to store only one copy of each attachment in the case of the present invention. The messages 4 do not have corresponding or attached binary objects.

### Extended Commands

The present invention introduces Universal Binary Object Identifier—a code that describes and uniquely identifies a binary object. This code is constructed with the purpose of reliably identifying binary objects. As mentioned above, a pair consisting of a CRC32 checksum and byte size of the object is considered to be reliable enough identifier for the purpose of this invention. If the probability of two objects having same size and CRC32 code is not low enough, other way of constructing UBOI can be chosen to make this probability as low as desired. For example, we can base UBOI on two CRC32 codes, where the first one is for the first half of the object, and the second one is for the second half of the object.

A full description of NNTP protocol is available at the website http://www.freesoft.org/CIE/RFC/Orig/rfc977.txt. In the text below we will only define extended versions of a few commands that we need for the purpose of our invention.

### XARTICLE Command

XARTICLE <message-id>[“*”|<UBOIₖ₁>, <UBOIₖ₂>, . . . ]

Send the header, a blank line, then the body (text) of the specified article with binary attachments replaced by their UBOIs. Then send all binary attachments if symbol “*” follows the message-id or only those binary attachments that correspond to UBOIs listed in the XARTICLE command.

Each binary attachment is sent as a sequence <headers \n\n length \n\n bytes \n\n> where headers is a set of ASCII text lines separated by new line (\n) characters. Length is a numeric value of the length of the binary object. Bytes are bytes of the binary object.

Message-id is the message id of an article as shown in that article's header. It is anticipated that the client will obtain the message-id and UBOIs from a list provided by the NEWNEWS command, from references contained within another article, or from the message-id provided in the response to some other commands.

### XBODY Command

XBODY command is identical to the XARTICLE command except that it does not send the header lines of the message.

### XIHAVE Command

XIHAVE <message-id>[<UBOI₁,>, <UBOI₂>, . . . ]

The XIHAVE command informs the server that the client has an article whose id is <message-id> and that includes the listed binary objects. If the server desires a copy of that article, it will return a response instructing the client to send the entire article. If the server does not want the article (if, for example, the server already has a copy of it), a response indicating that the article is not wanted will be returned.

Responses

235 article transferred ok

335 [“*”|<UBOIₖ₁,>, <UBOIₖ₂>, . . . ] send the article with the listed binary attachments

435 article not wanted—do not send it

436 transfer failed—try again later

437 article rejected—do not try again

If transmission of the article is requested, the client should send the article, including header, body, and requested binary objects in the manner specified for text transmission from the server (see XARTICLE command above). A response code indicating success or failure of the transferal of the article will be returned.

### XNEWNEWS Command

XNEWNEWS newsgroups date time [GMT][<distribution>]

For a full description of parameters of this command see description of the NEWNEWS command at the website: http://www.freesoft.org/CIE/RFC/Orig/rfc977.txt . XNEWNEWS sends a list of message-ids and UBOIs of articles and their attachments posted or received to the specified newsgroups since “date”. It differs from the NEWNEWS command only by including UBOIs after message-ids. The format of the listing will be one message-id per line, as though text were being sent, followed by UBOIs of its binary attachments. A single line consisting solely of one period followed by CRLF will terminate the list.

### XPOST Command

XPOST command is similar to XIHAVE command, but it does not include message-id. It does include UBOIs, however, and the server may decide that binary attachments do not have to be transmitted.

### Example of a News Transfer Session Using NNTP Protocol and Our Extensions

Using the news server to distribute news between systems.

Server: (listens at TCP port 119)

Client: (requests connection on TCP port 119)

Server: 201 Foobar NNTP server ready (no posting)

client asks for new newsgroups since 2 am, May 15, 1985)

Client: NEWGROUPS 850515 020000

Server 235 New newsgroups since 850515 follow

Server: net.fluff

Server: net.lint

. . .

Server:

(client asks for new news articles since 2 am, May 15, 1985)

Client: XNEWNEWS * 850515 020000

Server: 230 New news since 850515 020000 follows

(following article does not have a binary attachment)

Server: <1772@foo.UUCP>

(following article does not has a binary attachment with length 230543 bytes and CRC32 code 2938464828 )

Server: <87623@baz.UUCP><230543 2938464828>

(following article has two binary attachments, the first of them the same as in the previous message)

Server: <17872@GOLD.CSNET><230543 2938464828><298799 6534821>

Server:

(client asks for article <1772@foo.UUCP>)

Client: XARTICLE <1772@foo.UUCP>

Server: 220 <1772@foo.UUCP> All of article follows

Server: (sends entire message)

Server:

(client asks for article <87623@baz.UUCP> and its binary attachment)

Client: XARTICLE <87623@baz.UUCP><230543 2938464828>

Server: 220 <87623@baz.UUCP> The article and its attachment follow

Server: (sends message body)

Server:

Server: (sends binary attachment)

(client asks for article <17872@GOLD.CSNET> and only the second of its attachments because it already has the first one)

Client: XARTICLE <17872@GOLD.CSNET><298799 6534821>

Server: 220 <17872@GOLD.CSNET> The article and its attachment follow

Server: (sends message body)

Server:

Server: (sends requested binary attachment)

(client offers an article it has received recently)

Client: XIHAVE <4105@ucbvax.ARPA>

Server: 435 Already seen that one, where you been?

(client offers another article)

Client: XIHAVE <4106@ucbvax.ARPA><378699 666237><126789 76367>

Server: 335 * Send the article and all its attachments

Client: (sends textual body of the article)

Client:

Client: (sends first binary attachment)

Client: (sends second binary attachment)

Server: 235 Article transferred successfully. Thanks.

Client: QUIT

Server: 205 Foobar NNTP server bids you farewell.

### A First System

### Second Embodiment

### Global References and Binary Servers

As described above, the present invention stores binary attachments separately and stores only a reference to the binary attachment with the message. If we make this reference global, i.e. it can point to a binary object on another server, it makes it unnecessary to download the attachment until a user had requested it. More than this, user's client program can be referred to the actual server that has this binary object stored, so that it can download the binary object from that server. Thus, there is no need for the local news server to keep the attachment at all. This role can be appointed to a dedicated server that stores and serves binary objects to a sharing community of news servers.

This architecture of the system does make it relatively more complicated to determine that there are no references to a particular binary object in order to delete it, as references now can be global. However a heuristic criterion based on use pattern is available. If there are no requests for the object for a considerable time interval, it means that it can be safely deleted because, even if the referring messages have not been removed, users are not interested in this object.

Using global references, we can save local hard drive space at expense of global traffic. Storing all binary attachments locally, we can save global traffic at expense of the hard drive space. These are two extreme strategies. The optimal strategy is somewhere between them. It makes sense to store popular binary objects locally (cache them) to minimise global traffic, and the rest of binary objects may be stored on binary servers and referred to by global references.

A ‘global’ system can be implemented in accordance with the way as it has been described in the first embodiment, with minor changes:

1) store and transmit with each message global references to its binary attachments,

2) introduce a special command that lets to retrieve binary attachment only, without any regard to a particular message. We will call this command XBINARY. Its syntax is XBINARY <UBOI>. When a server receives this command, it will return success code followed by the binary object identified by the UBOI or error code if can not send the object.

### A First System

### Reliable Methods of Identification of Binary Objects—Third Embodiment

No matter how small, there is a probability that two different binary objects will have identical UBOIs. In case it proves to be important to avoid this occurrence, the present invention offers a number of reliable methods of attachment identification. These methods offer reliability at a cost of a small resource overhead. Please note that these methods are only concerned with assignment of reliable identifiers (that can be used instead/together with UBOs) to binary objects. Storage and exchange of binary objects are implemented in a way similar to that described above in first or second embodiments. The syntax and semantics of the introduced protocol commands must be adjusted correspondingly.

The present invention introduces RUBOI—Reliable Unique Binary Object Identifier. The difference between RUBOI and UBOI is that, by construction of RUBOIs, it is guaranteed that different binary objects have different RUBOIs.

Method A. Identification Request Broadcast

The suggested method is based on requesting of attachment identification information from other Usenet servers. We describe this method as a sequence of numbered steps below.

1. Server 1 receives a message containing a binary attachment that does not have a RUBOI assigned.

2. Server 1 builds UBOI for this attachment and checks if it has other attachments with this UBOI in its storage.

3. If there are such objects, Server 1 compares them to the new one byte-to-byte. If any of the old objects is identical to the new one the server uses its RUBOI. Thus, the attachment has been identified. Go to step 11.

4. If no identical objects found, Server 1 issues a request (system message) containing the UBOI of the new object and RUBOIs of the objects that have been compared to the new object, and posts this request in the Usenet.

5. Upon receiving this request, other servers check their sets of stored binary attachments.

6. If any server finds a binary object that has identical UBOI, and not listed in the request message, it responds with RUBOIs that have not been listed in the request message.

7. If after a pre-set waiting time Server 1 does not receive any messages, it assumes that no other objects with identical UBOI exist, and generates or obtains from a third party a new RUBOI for the new object. Go to Step 10.

8. If Server 1 receives any response messages, it chooses a set of servers that covers all RUBOIs that the new object has not been compared to, and sends the new object to these servers (preferably) or requests binary objects from them for comparison.

9. They compare the new object to their objects with the same UBOI and respond with RUBOI of the identical object, if found. In this case Server 1 uses the found RUBOI. Go to Step 11.

10. A simple method can be used to generate a new RUBOI. For example, RUBOI may be a string containing host and domain names of the Server 1, day and time stamp, and sequential number of the binary object from the start of the day. Alternatively, a new RUBOI can be obtained from a special server (a third party server that is authorised to generate and issue new RUBOIs).

11. End of work.

Method B. Recognition Event Broadcast

This method is based on broadcasting object equivalence information in the Usenet. Initially, every binary object that does not have a RUBOI is assigned a new RUBOI, unless the server that receives it, has this object already and recognises it. Then the server feeds this object to other servers. When any server establishes a fact (e.g. by comparison) that two identical objects have different RUBOIs RUBOI1 and RUBOI2, it posts a system message that notifies other servers that RUBOI1 is equivalent to RUBOI2. We describe this method as a sequence of numbered steps below.

1. Server 1 receives a message containing a binary attachment that does not have a RUBOI assigned, or has a new RUBOI suggested by the client.

2. Server 1 looks for an identical object in its storage. If any of the old objects is identical to the new one, the server uses its RUBOI. Go to Step 8.

3. If no identical objects found, Server 1 generates a new RUBOI for the object (or uses the one suggested by the client that posted the message). A simple method can be used to generate a new RUBOI. For example, RUBOI may be a string containing host and domain names of the Server 1, day and time stamp, and sequential number of the binary object from the start of the day. Alternatively, a new RUBOI can be obtained from a special server (a third party server that is authorised to generate and issue new RUBOIs).

4. Server 1 feeds the object with new RUBOI1 to the servers it is feeding.

5. After receiving the object, every Server 2 looks in its storage for an identical object.

6. If an object found that is identical, but has a different RUBOI2, Server 2 posts a system message that says that RUBOI1 is equivalent to RUBOI2. All servers that receive this message, can use this information later when handling new objects.

7. Steps 5 and 6 are repeated by every server when receiving the new binary object.

8. End of work.

Method C. Centralised Identification

This method is based on use of a central server that has the largest collection of binary objects in the Usenet. It is important (but not critical) that this server has binary object if any other news server has it. This rule is important to provide effective identification of binary objects. (If it is not 100% true, the system will still work, but different RUBOIs will be assigned to some identical binary objects. This will result in decreased efficiency.) We will call this “central identification authority” server Server 0. We describe this method as a sequence of numbered steps below.

1. Server 1 receives a message containing a binary object that does not have a RUBOI assigned or has one suggested by the client that has posted the message.

2. Server 1 checks if it has an identical binary object in its storage.

3. If any of the old objects is identical to the new one, the server uses its RUBOI1. Go to Step 6.

4. If no identical objects found, Server 1 sends the new object to Server 0 for identification. Server 0 looks in its collection for identical objects. If any found, Server 0 sends its RUBOI1 to Server 1 to use for the new object. Go to Step 6.

5. If no identical objects found, Server 1 generates a new RUBOI1 for the object or uses the one suggested by the client. A simple method can be used to generate a new RUBOI. For example, RUBOI1 may be a string containing host and domain names of the Server 1, day and time stamp, and sequential number of the binary object from the start of the day. Alternatively, a new RUBOI can be obtained from a special server (a third party server that is authorised to generate and issue new RUBOIs).

6. Server 1 feeds the object with RUBOI1 to the servers it is feeding.

7. End of work.

### Method D. Using Multiple Reliable Identifiers

This method is relatively simple. Each server in the path of the message containing a binary object adds to the header the RUBOI of this object if an identical object already exists in the collection of the server and its RUBOI is different from those that are already in the message header. Thus, the message will have in its header multiple identifiers for the carried binary object.

When this message is being offered to any server, it rejects the binary object if it has a binary object known by any one of the RUBOIs in the message header

### A First System

### Fourth Embodiment

In this embodiment, we disclose a set of commands functionally similar to the set of commands disclosed in the first embodiment, but adopted to the case when a reliable method of identification of binary attachments is used, namely, method D as disclosed in the third embodiment. As in the first embodiment, this invention can be implemented by changing the way news server stores messages in the database and introducing extended analogues of ARTICLE, BODY, IHAVE, NEWNEWS, STAT, XOVER and POST commands of the NNTP protocol. We will call them XBINARTICLE, XBINBODY, XBINIHAVE, XBINNEWNEWS, XBINSTAT, XBINOVER and XBINPOST respectively.

In addition, we are disclosing several new commands that designed to improve efficiency of the server and convenience of work for the user, namely XZIPARTICLE, XZIPBODY, XZIPIHAVE, XZIPNEWNEWS, XZIPSTAT, XZIPOVER, XBINZIPOVER, XLOGON, XBINSAMPLE and XZIPSAMPLE.

XLOGON command allows to perform user authentication based on their user name, password and/or IP address provided explicitly. Authentication based on explicitly provided IP address is useful when the user connects to the server via a third entity, such as a Web gateway. In this case, all connections come from the gateway's IP address, so, the IP address of the user can not be established based on the connection information.

XBINSAMPLE command allows to retrieve small previews of binary objects stored in the server in order to examine them before downloading decision is made. Thus, users can avoid downloading unwanted large objects and save time.

XZIPARTICLE, XZIPBODY, XZIPIHAVE, XZIPNEWNEWS, XZIPSTAT, XZIPOVER, XBINZIPOVER, and XZIPSAMPLE commands allow to request response sent in compressed format, to save transmission time and bandwidth resources.

This embodiment is not the only form in which the invention can be implemented, and thus the invention should not be limited to the embodiment disclosed.

In terms of this invention, as in the first embodiment, the server will store message bodies and binary attachments separately. Only a reference to the binary attachment will be stored with the message. On the other side, with each binary object an integer number will be stored with the value equal to the number of messages referring to this binary object. If this number is zero, no messages in the server's database have this object as a binary attachment and the object can be safely removed. However, it can be considered keeping “unattached” objects in the database for a while, just in case that they will be re-posted with a new message soon.

FIG. 1 illustrates transition from storing binary attachments 1 in messages 2 to storing binary attachments 1A, 1B, etc separately and providing references 3 from the corresponding messages 2A, 2B, etc to their corresponding binary attachments. There are two different binary attachments in the picture, each is shared among 3-4 messages. We need to store only one copy of each attachment in the case of the present invention. The messages 4 do not have corresponding or attached binary objects.

### Extended Commands

A full description of NNTP protocol is available in [2]. In the text below we will only define extended versions of a few commands that we need for the purpose of our invention.

### XBINARTICLE Command

XBINARTICLE {<message-id>|nnn}[{“*”|{UBOI₁|−}RUBOI₁. . . }]

Before each RUBOI in the command, there must be a correspondent UBOI or “−” if it is omitted. There may be several pairs or UBOIs and RUBOIs in one command.

Send the header, a blank line, then the body (text) of the specified article with binary attachments replaced by their RUBOIs. The body is terminated by the sequence “\r\n.\r\n” (a single dot in line). If the body is not ordered, this terminator is not used

Then send all binary attachments if symbol “*” follows the message-id or only those binary attachments that correspond to RUBOIs listed in the XBINARTICLE command.

Each binary attachment is sent as a sequence <headers \r\n\r\n length \r\n bytes \r\n> where headers is a set of ASCII text lines separated by carriage return and new line (\r\n) characters. Length is a numeric value of the length of the binary object. Bytes are bytes of the binary object.

Message-id is message id of the article as shown in that article's header. It is anticipated that the client will obtain the message-id, UBOIs and RUBOIs from a list provided by the XBINNEWNEWS command, from references contained within another articles, or from the message-id provided in responses to some other commands, such as XBINSTAT.

After all attachments, a terminating string “\r\n.\r\n is sent.

In detail:

If there is no argument, current article is sent in the following way:

“222 article-number <message-id> article retrieved—body & attachments follow\r\n”

The article's body is sent and is terminated by the string “\r\n.\r\n.

If there is a first argument, the specified by it article and attachments are sent in the following way:

“222 article-number <message-id> article retrieved—body & attachments follow\r\n”

The article's body is sent and is terminated by “\r\n.\r\n.

Attachments are sent (see below, it may be that there is no one)

Terminating string “\r\n.\r\n is sent.

Sending attachments:

If the second argument is equal to “*”, all article attachments are sent, otherwise for each pair of the command arguments, beginning with the second argument, attachment is sent that is defined by this arguments pair (UBOI/RUBOI). The UBOI may be skipped (“−” in the command instead).

Sending one attachment:

ContentID: <content_id>\r\n

FileName: <file_name>\r\n

Possibly, more headers . . .

\r\n

length (as characters)\r\n

<body of attachment>

\r\n

### XBINBODY Command

XBINBODY {<message-id>|nnn|−}[{“*”|{UBOI₁|−}RUBOI₁, . . . }]

XBINBODY is a command similar to the XBINARTICLE command. The only difference is, it allows to skip textual body of the article, if it is not needed, and retrieve only attachments by their RUBOIs.

Understandably, if the body of the article is being skipped (nor message-id, nor article number are specified, there is a “−” instead of them), “*” can not be the second argument, as there is no association with any particular article.

Before each RUBOI in the command, there must be a correspondent UBOI or “−” if it is omitted. There may be several pairs or UBOIs and RUBOIs in one command.

Send the header, a blank line, then the body (text) of the specified article with binary attachments replaced by their RUBOIs. The body is terminated by the sequence “\r\n.\r\n” (a single dot in line). If the body is not ordered, this terminator is not used.

Then send all binary attachments if symbol “*” follows the message-id or only those binary attachments that correspond to RUBOIs listed in the XBINBODY command.

Each binary attachment is sent as a sequence <headers \r\n\r\n length \r\n bytes \r\n> where headers is a set of ASCII text lines separated by carriage return and new line (\r\n) characters. Length is a numeric value of the length of the binary object. Bytes are bytes of the binary object.

Message-id is message id of the article as shown in that article's header. It is anticipated that the client will obtain the message-id, UBOIs and RUBOIs from a list provided by the XBINNEWNEWS command, from references contained within another articles, or from the message-id provided in responses to some other commands, such as XBINSTAT.

After all attachments, a terminating string “\r\n.\r\n is sent.

In detail:

If there is no argument, current article is sent in the following way:

“222 article-number <message-id> article retrieved—body & attachments follow\r\n”

The article's body is sent and is terminated by the string “\r\n.\r\n.

If the first argument is not equal to “−”, the specified by it article and attachments are sent in the following way:

“222 article-number <message-id> article retrieved—body & attachments follow\r\n”

The article's body is sent and is terminated by “\r\n.\r\n.

Attachments are sent (see below, it may be that there is no one)

Terminating string “\r\n.\r\n is sent.

If the first argument is equal to “−” only the specified attachments are sent in the following way:

“223 attachments follow\r\n”

Attachments are sent (see below, it may be that there is no one)

Terminating string “\r\n.\r\n is sent.

Sending attachments:

If the second argument is equal to “*”, all article attachments are sent, otherwise for each pair of the command arguments, beginning with the second argument, attachment is sent that is defined by this arguments pair (UBOI/RUBOI). The UBOI may be skipped (“−” in the command instead).

Sending one attachment:

ContentID: <content_id>\r\n

FileName: <file_name>\r\n

Possibly, more headers . . .

\r\n

length (as characters)\r\n

<body of attachment>

\r\n

### XZIPBODY Command

XZIPBODY {<message-id>|nnn|−}[{“*”|{UBOI₁|−}RUBOI₁. . . }]

XZIPBODY command is analog of the XBINBODY command, but response is sent in compressed format, except the first (status) line.

In response, server sends the following sequence:

1. Status line is sent in text format, terminated by “\r\n”, such as

“222 article-number <message-id> article retrieved—body & attachments follow\r\n”

or “222 article-number <message-id> article retrieved—body & attachments follow\r\n”

or “223 attachments follow\r\n”

2. Length of compressed response body is sent, followed by “\r\n” followed by length of uncompressed response body, followed by “\r\n”.

3. Response body is sent in compressed format.

In case of an error, only the status line containing a short description of the error is sent.

### XBINSAMPLE Command

XBINSAMPLE {<message-id>|nnn|−}[{“*”|{UBOI₁|−}RUBOI₁, . . . }]

XBINSAMPLE command is similar to the XBINBODY command, except that instead of binary objects, their samples (preview objects, such as thumbnails for images) are sent. Textual message bodies are not sent.

### XZIPSAMPLE Command

XZIPSAMPLE {<message-id>|nnn|−}[{“*”|{UBOI₁|−}RUBOI₁. . . }]

XZIPSAMPLE command is analog to the XBINSAMPLE command, except that response is sent in compressed format.

In response, server sends the following sequence:

1. Status line is sent in text format, terminated by “\r\n”.

2. Length of compressed response body is sent, followed by “\r\n\” followed by length of uncompressed response body, followed by “\r\n”.

3. Response body is sent in compressed format.

In case of an error, only the status line containing a short description of the error is sent.

### XBINIHAVE Command

XBINIHAVE {<message-id>|−}[(UBOI₁, [RUBOI₁. . . ]) . . . ]

The XBINIHAVE command informs the server that the client has an article whose id is <message-id> and that includes the listed binary object. Every attachment may have multiple RUBOIs. Information about every attachment is enclosed in separate “( )”.

If the server desires a copy of any of the components being offered, it will return a response instructing the client to send the wanted components. If the server does not want the article (if, for example, the server already has a copy of it), a response indicating that the article is not wanted will be returned. Responses

235 article transferred ok

335 *send the article with all the binary attachments

335 <message-id> send the article, no attachments wanted

335 <message-id>RUBOI₁, . . . —send the article and selected attachments

335—RUBOI₁, . . . —don't send the article, only send selected attachments

435 article not wanted—do not send it

436 transfer failed—try again later

437 article rejected—do not try again

If transmission of the article is requested, the client should send the article, including header, body, and requested binary objects in the manner specified for text transmission from the server (see XBINBODY command above). A response code indicating success or failure of the transferal of the article will be returned.

### XZIPIHAVE Command

XZIPIHAVE {<message-id>|−}[(UBOI₁, RUBOI₁. . . ]) . . . ]

The XZIPIHAVE command is analog to the XBINIHAVE command, except if the server wants suggested items and gives Ok to transfer, the client sends them in compressed mode, as it is described above in XBINBODY command.

In response, client sends the following sequence:

1. Status line is sent in text format, terminated by “\r\n”.

2. Length of compressed response body is sent, followed by “\r\n\” followed by length of uncompressed response body, followed by “\r\n”.

3. Response body is sent in compressed format.

In case of an error, only the status line containing a short description of the error is sent.

### XBINNEWNEWS Command

XBINNEWNEWS newsgroups date time [GMT][<distribution>]

For a full description of parameters of this command see description of the NEWNEWS command in definition of NNTP.

XBINNEWNEWS sends a list of message-ids and UBOIs and RUBOIs of articles and their attachments posted or received to the specified newsgroups since “date” and “time”. It differs from the NEWNEWS command only by including UBOIs after message-ids. The format of the listing will be one message-id per line, as though text were being sent, followed by UBOIs and RUBOIs of its binary attachments. UBOIs and RUBOIs describing each attachment are enclosed in a separate pair of “( )”. A single line consisting solely of one period followed by CR-LF will terminate the list.

### XZIPNEWNEWS Command

XZIPNEWNEWS command is a version of XBINNEWNEWS command where server's response is sent in compressed format, in a way described above for other commands with XZIP prefix in the names.

### XBINPOST Command

XBINPOST [(UBOI₁[RUBOI₁. . . ]) . . . ]

XBINPOST command is similar to XBINIHAVE command, but it does not include message-id. It does include UBOI, (and optionally, RUBOIs) however, and the server may decide that binary attachments do not have to be transmitted. Responses

235 article transferred ok

340 * send the article with all binary attachments

341 send the article, no attachments wanted

340 UBOI₁, . . . —send the article and selected attachments

440 article not wanted—do not send it

436 transfer failed—try again later

If transmission of the article is requested, the client should send the article, including header, body, and requested binary objects in the manner specified for text transmission from the server (see XBINBODY command above). A response code indicating success or failure of the transferal of the article will be returned.

Posting one attachment (similar to XBINBODY):

ContentID: <content_id>\r\n

FileName: <file_name>\r\n

Possibly, more headers . . .

\r\n

length (as characters)\r\n

<body of attachment>

\r\n

### XZIPPOST Command

XZIPPOST command is version of XBINPOST command where client transfers article and, possibly, attachments, in compressed format in a way described for XZIPIHAVE command.

### XBINSTAT Command

XBINSTAT_|n|<message_id >

XBINSTAT command returns article status information and a list of its attachments. Query arguments are identical to that of the command STAT of the NNTP protocol. XBINSTAT returns status line with error code, then article's message-id. Then, for every attachment, a line is formed that consists of attachment's UBOI, file name, file size and RUBOIs. The response is terminated by “\r\n.\r\n”.

### XZIPSTAT Command

This is version of XBINSTAT command that sends its response in compressed format, used for other commands with XZIP prefix in names.

### XZIPOVER Command This is version of NNTP XOVER command that sends its response in compressed format, as it is described for other commands with XZIP prefix in names.

### XBINOVER Command

This is version of NNTP XOVER command that includes in its response attachment information for every message. It places this information in the overview field that contains message-ids in the standard NNTP XOVER command.

In the standard XOVER command, this field has format:

<message-id>[. . . ]

because each message may have several message-ids. We change this format to

<message-id>[. . . ][({−|UBOI}RUBOI . . . ) . . . ]

This means, that this field contains a sequence of message-ids of the message, followed by a sequence of UBOIs and RUBOIs of each binary attachment, information about each binary attachment being enclosed in “( )”.

### XZIPBINOVER Command

This is version of XBINOVER command that sends its response in compressed format, as it is described for other commands with XZIP prefix in names.

### XLOGON Command

XLOGON <ip_addr>[<user_name><password>]

XLOGON command establishes a new connection context. It changes identity of the user associated with this connection. The server performs authentication check and responds similarly to a connection establishing request in NNTP. There are three possible server's return codes as the response to this command:

281 Authentication ok—if the user is permitted connection

502 Authentication error—if authentication failed

501 command syntax error—if syntax error occurred

### A second System

### First Embodiment

Practical implementation of this invention does not require changing of involved standards, such as NNTP, MIME etc. It only requires modification of posting and downloading news clients so that they would add some extra information to messages' and MIME encoded objects' headers during the posting stage and could interpret this information during the downloading stage.

To describe how the system works, we will take as a base work of a standard newsreader e.g. Netscape newsreader that is a part of Netscape Communicator package, Version 4.06. Those skilled in the art are familiar with use of a typical news client. We will describe how the client works in our embodiment. To do this, we will describe what it does differently or additionally to the Netscape news client.

There are two tasks that are performed differently: posting and representing. We will describe each of them.

### Posting

The task is to post a collection of one or more multimedia objects. The client does it as normally, with only one difference: if it detects that a message to be posted contains a multimedia object(s), it generates one header for each object and inserts it in the head of the message. In this embodiment, the format of this header is as follows:

X-meta-tag: ‘<’<CRC32 of the object>-<size of the object>-<time stamp>‘>’

Where

CRC32 of the object is a numeric CRC32 code of the object;

Size of the object is number of bytes in the object;

Time stamp is time when the header was generated, with milliseconds.

After this the client creates a metadata description item for each multimedia object in the message and temporarily stores it locally with a tag corresponding to the string in the X-meta-tag header.

The client automatically creates and posts metadata description messages in one or more (this may be controlled by configuration parameters of the client) of the following events:

1. At the end of the session;

2. Every time when the volume of stored metadata items exceeds some threshold;

3. At regular time intervals;

4. By explicit user request.

The temporarily stored metadata description items that have not been posted before are posted in such messages and then deleted. Each metadata description message is a normal news message containing a set of multimedia objects that are metadata description items of the multimedia objects posted before.

Each metadata description message contains a header in format:

X-metadata: yes

This header allows clients to recognise such messages and download them to present metadata to users for selection.

Each metadata object is MIME encoded and its encoding contains a Content-Description header in format:

Content-Description: “X-meta-tag: ‘<’<CRC32>-<size>-<time stamp>‘>”’

Where the CRC32, size and time stamp values are the same as in the X-meta-tag header of the message that includes the object described by this metadata object.

Example.

First message:

From: catlover@cats.society.org

Newsgroups: alt.binaries.nospam.cats.sleeping

Subject: Pajama Party! Day 2 by popular demand!—090pjp.jpg (1/1) Date: Jul. 14, 1999 02:42:34 GMT

X-meta-tag: <098283278219-29875-19990714024234123>

Organization: Cats Society Inc.

Lines: 424

<message body including the first binary object>

Second Message:

From: catlover@cats.society.org

Newsgroups: alt.binaries.nospam.cats.sleeping

Subject: Pajama Party! Day 2 by popular demand!—091pjp.jpg (1/1)

Date: Jul. 14, 1999 02:45:28 GMT

X-meta-tag: <98273028763-32954-19990714024528265>

Organization: Cats Society Inc.

Lines: 487

<message body including the second binary object>

Metadata description message:

From: catlover@cats.society.org

Newsgroups: alt.binaries.nospam.cats.sleeping

Subject: Collection description message

Date: Jul. 14, 1999 03:15:20 GMT

X-metadata: yes

Organization: Cats Society Inc.

Lines: 96

MIME-Version: 1.0

Content-Type: multipart/mixed;

boundary=“-------- 5C8B558FFD309376B5A78B9”

This is a multi-part message in MIME format.

--------------5C18B558FFD309376B5A78B9

Content-Type: image/jpeg; name=“thumbnail-090pjp.jpg”

Content-Transfer-Encoding: base64

Content-Disposition: inline; filename=“thumbnail-090pjp.jpg”

Content-Description: “X-meta-info: <098283278219-2987519990714024234123>”

<thumbnail of the image 090pjp.jpg>

--------------5C18B558FFD309376B5A78B9

Content-Type: image/jpeg; name=“thumbnail-091pjp.jpg”

Content-Transfer-Encoding: base64

Content-Disposition: inline; filename=“thumbnail-091 pjp.jpg”

Content-Description: “X-meta-info: <98273028763-3295419990714024528265>”

<thumbnail of the image 091pjp.jpg>

--------------5C18B558FFD309376B5A78B9--

### Representing

The task is to represent available news articles to the end user using available metadata to make a better representation. E.g., normally, only such information as subject, size, poster, date and time of posting is represented about each article, but for multimedia objects this is clearly not enough. If an image thumbnail is available for image that is contained in article, this thumbnail should be found and used for article representation because in most cases it describes the image better than words of the subject line.

The client accomplishes this task in the following way. The client downloads heads of available news articles as normally. It searches the heads to find ones that contain header “X-metadata: yes”. When such header is found, the client automatically downloads the message, parses it (as normally for MIME formatted messages), extracts metadata description items and temporarily stores them with the tags that are found in their “Content-Description” headers.

When building a list of available articles for the user to select from, the client checks each article head whether it contains an “X-meta-tag” header. If yes, the client searches for a stored metadata item that has a correspondent “X-meta-tag” stored with it.

If a correspondent metadata item found, the client uses it to represent the article it relates to. For example, an image thumbnail is used to represent an article that contains the image, a movie clip can be used in representation of an article that contains a movie attached etc. The client also memorizes the association between the metadata item and the article it represents to use it to download articles represented by metadata items selected by the user.

The user than can make a better informed downloading decision if they have better described articles to select from.

Once metadata objects are selected, the articles are established via associations with metadata objects, the articles are downloaded and presented in a normal way.

### A Second System

### Second Embodiment

The difference between first and second embodiments of this aspect is that the second embodiment uses an alternative way of embedding information about associations between metadata containing messages (indexes) and the objects being described by the metadata information.

This method has an advantage that information allowing to establish these associations is contained in parts of headers that are retrieved as a result of XOVER command. Thus, additional retrieval of message headers is not needed and this may be a very substantial saving when newsgroup is very large.

As in the first embodiment, to describe how the system works, we will take as a base work of a standard newsreader e.g. Netscape newsreader that is a part of Netscape Communicator package, Version 4.06. Those skilled in the art are familiar with use of a typical news client. We will describe how the client works in our embodiment. To do this, we will describe what it does differently or additionally to the Netscape news client.

There are two tasks that are performed differently: posting and representing. We will describe each of them.

### Posting

The task is to post a collection of one or more multimedia objects.

First, the client generates a unique for this poster collection id—an integer number, say, within range between 0 and 65535. A simple practical way to generate this number is to number posted collections sequentially, starting with 0. It is highly unlikely that anyone would post more than 65535 collections in their entire life. Even if this happens, they can change one character in their poster name and start collection count from 0 again.

Then the client starts posting collection messages and counting posted multimedia objects. If it detects that a message to be posted contains a multimedia object(s), it increases the counter of objects by 1 and appends a string containing its value to the subject of the message, along with the collection number.

If there are several multimedia objects posted in a single message, they are numbered sequentially, and instead of one value, a range is placed in the subject.

For example, let collection number be 123, object numbers 45, 46, 47 and 48, and original subject of the message, “Cute kittens number one, two, free and four”. In the process of posting, the client will modify the subject in the following way, “Cute kittens number one, two, three and four id=123:45-48”.

Here appended to the subject string contains information that this message contains objects 45, 46, 47 and 48 from the collection number 123. Along with the poster and other fields, also available from the XOVER command, this information is sufficient to establish associations between the objects and the metadata.

After this the client creates a metadata description item for each multimedia object in the message and temporarily stores it locally with a tag corresponding to the number of the object.

The client automatically creates and posts metadata description messages in one or more (this may be controlled by configuration parameters of the client) of the following events:

1. At the end of the session;

2. Every time when the volume of stored metadata items exceeds some threshold;

3. At regular time intervals;

4. By explicit user request.

The temporarily stored metadata description items that have not been posted before are posted in such messages and then deleted. Each metadata description message is a normal news message containing a set of multimedia objects that are metadata description items (for example, thumbnails for images) of the multimedia objects posted before.

Each metadata description message contains a subject in which there is the number of the collection it describes, for example, “Cute kittens collection index id=123”.

A string in form “collection index id=number” allows clients to recognize collection description messages and download them to present metadata to users for selection.

Each metadata object is MIME encoded and its encoding contains a Content-Description header in format:

Content-Description: “Object id=number”

Example.

First message:

From: catlover@cats.society.org

Newsgroups: alt.binaries.nospam.cats.sleeping

Subject: Pajama Party! Day 2 by demand!-090pjp.jpg (1/1) id=2:1

Date: Jul. 14, 1999 02:42:34 GMT

Organization: Cats Society Inc.

Lines: 424

<message body including the first binary object>

Second message:

From: catlover@cats. society. org

Newsgroups: alt.binaries.nospam.cats.sleeping

Subject: Pajama Party! Day 2 by demand!-091 pjp.jpg (1/1) id=2:2

Date: Jul. 14, 1999 02:45:28 GMT

Organization: Cats Society Inc.

Lines: 487

<message body including the second binary object>

Metadata description message:

From: catlover@cats.society.org

Newsgroups: alt.binaries.nospam.cats.sleeping

Subject: Collection description message index id=2

Date: Jul. 14, 1999 03:15:20 GMT

Organization: Cats Society Inc.

Lines: 96

MIME-Version: 1.0

Content-Type: multipart/mixed;

boundary=“------------5C18B558FFD309376B5A78B9”

This is a multi-part message in MIME format.

--------------5C18558FFD309376B5A78B9

Content-Type: image/jpeg; name=“thumbnail-090pjp.jpg”

Content-Transfer-Encoding: base64

Content-Disposition: inline; filename=“thumbnail-090pjp.jpg”

Content-Description: “Object id=2:1”

<thumbnail of the image 090pjp.jpg>

--------------5C1 8B558FFD309376B5A78B9

Content-Type: image/jpeg; name=“thumbnail-091pjp.jpg”

Content-Transfer-Encoding: base64

Content-Disposition: inline; filename=“thumbnail-091 pip .jpg”

Content-Description: “Object id=2:2”

<thumbnail of the image 091 pjp.jpg>

--------------5C1 8B558FFD309376B5A78B9--

### Representing

The task is to represent available news articles to the end user using available metadata to make a better representation. E.g., normally, only such information as subject, size, poster, date and time of posting is represented about each article, but for multimedia objects this is clearly not enough. If an image thumbnail is available for image that is contained in article, this thumbnail should be found and used for article representation because in most cases it describes the image better than words of the subject line.

The client accomplishes this task in the following way. The client requests XOVER information about available news articles as normally. It searches the subjects to find ones that contain string “index id=number”. When such subject is found, the client automatically downloads the message, parses it (as normally for MIME formatted messages), extracts metadata description items and temporarily stores them with the tags that are found in their “Content-Description” headers.

When building a list of available articles for the user to select from, the client checks each article subject whether it contains a “id=number:number” string. If yes, the client searches for a stored metadata item that has a correspondent tag stored with it and is posted by the same poster.

If a correspondent metadata item found, the client uses it to represent the article it relates to. For example, an image thumbnail is used to represent an article that contains the image, a movie clip can be used in representation of an article that contains a movie attached etc.

The user than can make a better informed downloading decision if they have better described articles to select from.

Once selected, the articles are downloaded and presented in a normal way.

### Inventive Aspects

### First Embodiment

### Architecture of the System

In this embodiment, our system includes the following components, as it is shown in the FIG. 5:

1. User accessing WWW using their client (2).

2. WWW client, such as Netscape or IE.

3. Client Side Caching Agent—a program that performs client side parts of our method.

4. Usenet server that is local to the client.

5. Internet.

6. Server Side Caching Agent—a program that performs server side parts of our method.

7. Usenet server that is local to the original Web server.

8. Web server—the original server that contains resources that the user wants to download.

CSCA must be placed on the TCP/IP path from the client to the Web server, or from the client to the client's cache engine. This placement is important to ensure that all requests from the client to the Web are passed through the CSCA.

CSCA performs the following functions:

Analyses Web requests containing URLs of required objects.

Based on the URL, decides, whether an object has been posted to the Usenet by its original server and thus, may be found in the Usenet.

If the object has not been posted to the Usenet, CSCA passes the request further for normal processing by the original Web server or cache engine. If the object has been posted to the Usenet:

Based on its configuration information, CSCA selects one or more available Usenet servers and tries to find the required object on them.

If the object is found, CSCA retrieves it and returns to the client.

If the object is not available, CSCA passes the request for further processing by the original server or a caching engine.

SSCA must be placed on the path connecting the original server with the Internet, before server side cache engines and/or the server. This placement is important to ensure that all requests from clients to the server first reach the SSCA and then the server or its server side cache engines.

SSCA performs the following functions:

1. Intercepts all requests to the server and identifies those that are requesting Usenet posted objects. If such a request is found, the SSCA cleans up its URL, removing its part that concerns newsgroups. This function is optional because the required information can be included in the URL and combined with object placement in such a way, that no cleaning is necessary. (This will be discussed below.) Once cleaned, the URL is passed further for processing by the server or server side cache engine.

2. Traces events of modification of the server objects that are to be, or have been posted to the Usenet. If an object has been modified (or created), the SSCA cancels its previous versions, if necessary (by canceling previously posted messages) in the Usenet and posts a new digitally signed one.

3. SSCA may also periodically re-post objects to the Usenet to ensure their availability.

The only mandatory function of SSCA is ensuring availability of the objects in the Usenet. However, this function can be performed by CSCAs on behalf of the original server, as discussed below. Thus, SSCA is not an essential element of the system, but its availability makes easier implementation of certain features: validation of objects, access control and traffic billing, without modifying Web servers.

Obviously, CSCA and SSCA can be independent applications, or CSCA can be built into client and/or client side cache engine, and SSCA can be built into Web server and/or server side cache engine.

The described above system is functional, but it can be improved in several aspects.

### Validation and Availability of Objects

When a client requests an object, it must receive its current, valid version. This is not hard to ensure using validation requests in step 6 of CSCA actions. If the object is found, CSCA sends its version information, such as UBOI, to the SSCA, or a standard HTTP validation request to the original server. If the object is current, and only if, it will be send to the client. So, the problem of validation is not a hard one. Given that most Usenet cached objects are large, expenses on their validation are negligible compared to the transmission cost.

If the object is not found on available Usenet server, or its version is not current, CSSA may perform the following actions:

1. Retrieve the object from the original server.

2. Receive digitally signed by the SSCA permission to post it on behalf of the original server and to cancel the expired version, if any.

3. Send this permission to one or more of local Usenet servers and post the object.

The advantage of doing this is that outdated versions of Usenet cached objects will be promptly replaced by current versions, possibly, almost simultaneously in many Usenet servers. Thus, changes would propagate very fast. The other advantage is that even no posting is necessary because, if the object is to be cached, it will be retrieved by CSSAs and posted by them on behalf of the server. This ensures wide availability of current objects and fast propagation of changes.

### Access Control

It is not hard to ensure access control as well. When a CSCA requests object validation information, it can also ask for a permission to serve this object to the client that requested it. If permission is granted, the CSCA sends it to the Usenet server when retrieving the object from there.

### Billing and Paying for Resources

Establishing a traffic billing system can represent a problem in such anarchic environment as the Internet. However, it is practical to do in the system being invented.

Each message in the Usenet has so called Path header. In this Path, there are listed all servers that the message came through. This information can be used to establish the servers participated in transmission in order to share awards.

It seems to be practical to implement it in the following way:

A participating Usenet server, having received from a CSCA a digitally signed by the original server permission to receive an object, takes Path information from the correspondent message, appends it to the permission, and sends up the Path (to the previous server in the Path). Each server in the Path does it until the “bill” reaches the original Web server. At this time, each participant knows what was the size of the object and what was the way the object has passed before reaching its destination, and based on this information, they can do the billing.

### URL Encoding of Usenet Information

We will disclose below three methods that allow to transparently encode in objects' URLs information necessary to locate the object in a Usenet server and retrieve it. Any of these methods may be used in our system. These methods allow transparent retrieving of news cached objects from their original servers, in case if no CSCA is installed on the client side and no SSCA is installed on the server side. If we can assume that at least one of these agents is always installed, it can perform URL translation (for example, clear URLs of Usenet related parameters), and the problem discussed here becomes trivial.

These methods allow retrieving of the objects by standard HTTP requests even if there is no SSCA installed in the server's front end.

The problem to be solved: we want to post a Web object to the newsgroups and place it on a Web server so, that its URL on the Web server would also unambiguously identify it in the Usenet

### Method of Encoding Message-Id in Specific Directory Name

This method is based on constructing and using specific directory names for news cached objects, in such a way, that there is a one-to-one mapping between the object's path on the Web server and its newsgroup and message-id in the Usenet.

Step 1.

Input:

Construct message-id—message-id to be assigned to the message that will contain the object.

All characters in the message-id, that are not allowed in directory names or in URLs, are substituted with their ASCII codes in hexadecimal notation, preceded by an underscore. All underscores are replaced by double underscores.

Result:

Encoded-message-id that does not contain characters illegal for directory names or URLs.

Step 2.

Input:

The original URL of the object identifying the place where the object is now.

Encoded-message-id.

In the URL, at the end of the path (right before the object's file name) insert the following string, “usenetcached/encoded-messa ge-id”.

Result:

Modified URL that contains information that the object has been posted to the Usenet (this conclusion can is made based on presence in the URL of the special string “usenetcached”), and name of its message-id is available after decoding—a process that is reverse to the process of encoding described in step 1.

Step 3.

In the current directory of the project on the Web server, create a subdirectory with name “usenetcached/encoded-message-id” and move the object there.

Step 4.

Use XBINUPDATE command as described below, or its analogs to post the message to the required newsgroup with the required message-id.

### Method of Using the URL as Message-Id

This method is based on constructing and using specific directory names for news cached objects, so, that there is a one-to-one mapping between the object's path on the Web server and its newsgroup and message-id in the Usenet.

Step 1.

Input:

The original URL of the object identifying the place where the object is now.

In the URL, at the end of the path (right before the object's file name) insert the following string, “usenetcached/”.

Result:

Modified URL that shows that this object has been posted to the Usenet.

Step 2.

In the current directory of the object on the Web server, create a subdirectory with name “usenetcached” and move the object there.

Step 3.

Input:

Modified URL—result of the step 1.

All characters in the URL, that are not allowed in message-ids, are substituted with their ASCII codes in hexadecimal notation, preceded by an underscore. All underscores are replaced by double underscores.

Result:

Encoded-URL that does not contain characters illegal for Usenet message-ids.

Step 4.

Now the encoded-URL may be (optionally) modified to look like a usual message-id, for example, from protocol://hostname:port/path to path-port-protocol@ host. Protocol and port are omitted if they are http and/or 80 respectively. This modification is optional for this method. However, if it is implemented, it is important that it becomes a part of convention, CSCA is aware of it and is able to transform URL to a message-id in equivalent way.

Use XBINUPDATE command as described below, or its analogs to post the message to the required newsgroup with the <encoded-URL> (or its modification) as the message-id.

### Method of Encoding Message-Id in URL Query Parameters

This method id based on passing the information in the query part of the URL. Because we are retrieving a file, this part would normally be ignored by Web servers. Even if we were retrieving a dynamic object that required passing query parameters, extra parameters are also normally ignored by CGI scripts processing queries.

Step 1.

Input:

Construct message-id—message-id to be assigned to the message that will contain the object.

All characters in the message-id, that are not allowed in URLs, are substituted with their ASCII codes in hexadecimal notation, preceded by an underscore. All underscores are replaced by double underscores.

Result:

Encoded-message-id that does not contain characters illegal for URLs.

Step 2.

Input:

The original URL of the object identifying the place where the object is now.

Encoded-message-id.

If the URL already contains character “?” followed by a query, append the following string at its end, “&ucached_id=encoded-message-id”.

Else add the following string, “?ucached_id=encoded-message-id”.

Result:

Modified URL that contains information that the object has been posted to the Usenet (this conclusion can be made from presence in the URL of the special string “ucached_id=”), and name of its message-id is available after decoding—a process that is reverse to the process of encoding described in step 1.

Step 3.

Use XBINUPDATE command as described below, or its analogs to post the message to the required newsgroup with the required message-id.

### NNTP Extensions Sufficient to Implement the System

We disclose a set of NNTP extensions that are sufficient (together with the first aspect of invention and properly implemented SSCA and CSCA modules) to build a system that implements Usenet-based caching of Web objects.

We do not describe syntax of all commands, messages, message headers, electronic signatures, certificates and bills because there are many ways syntax may be agreed upon, this issue is trivial for a person skilled in the art, and detailed description of it only makes understanding of this invention harder.

Therefore, we are concentrating on disclosing of things that are less trivial.

### Protecting Access to the Messages

When posting messages, original servers can explicitly mark them as write-protected and/or read-protected. By default, all messages are write-protected, but not read-protected. Access protection information is contained in invented by us header with name X-Access-Protection. If this header has string write=no”, it changes write protection of the message from the default mode. If this header has string “read=yes”, it changes read protection of the message from the default mode.

This header can also contain strings “write=yes” and “read=no”, but they do not change default protection mode and therefore may be omitted as well as the whole header if massage has default protection.

If the message is write-protected, it may not be modified or deleted by commands coming from anyone but the original poster or trusted Usenet servers. Other agents have to supply an explicit digitally signed by the original poster certificate that states that they have permission to modify or cancel this message, before they can do so.

If the message is read-protected, its contents may not be served to anyone but trusted Usenet servers. Other agents have to supply an explicit digitally signed by the original poster certificate that states that they have permission to receive this message, before they can do so.

### XBINUPDATE Command

XBINUPDATE <message-id>[(UBOI₁, [RUBOI₁. . . ]) . . . ]

This command is similar to the XBINIHAVE command described above in the fourth embodiment of the first aspect. Syntactically, the difference is that the message-id parameter is compulsory.

This command updates the message on the receiving side.

If the message is write-protected and the client is not the original poster or a trusted Usenet server, the server responds with code that requests a digitally signed by the original poster permission to modify the message.

If the client has the permission, it sends it to the server.

The receiver (the server) checks whether it has a message with such message-id and attachments. If there is no such message or it has a different set of attachments, the server accepts the message and/or those attachments that don't match, and substitutes with them the existing message and attachments (if any).

The resulting message on the server is now identical to the message that was offered by the sender. The server attempts to distribute it to the servers it feeds.

### XZIPUPDATE Command

XZIPUPDATE command is an analog of the XBINUPDATE command, but the information is transferred in compressed format, as in other XZIP commands described above.

### XBINGET Command

XBINGET <message-id>[{“*”|{UBOI₁|−}RUBOI₁. . . }]

This command is similar to the XBINBODY command described above in the fourth embodiment of the first aspect. Syntactically, the difference is that the message-id parameter is compulsory.

This command retrieves the message and required attachments.

If the message is read-protected and the client is not the original poster or a trusted Usenet server, the server responds with code that requests a digitally signed by the original poster permission to access the message.

If the client has the permission, it sends it to the server.

The receiver (the server) checks whether it has a message with such message-id and attachments. If there is one, it sends the requested message and attachments to the client.

The server may also be configured to ask a digitally signed receipt from the client, certifying that the client received the message.

### XZIPGET Command

XZIPGET command is an analog of the XBINGET command, but the information is transferred in compressed format, as in other XZIP commands described above.

### XBILL Command

This command is used to send signed receipts upstream. XBILL

The command consists of the command line “XBILL\r\n” followed by text of receipt terminated by “\r\n.\r\n”.

The receiving server may request to repeat the command if transmission has failed for any reason.

Receipts are digitally signed confirmations of receiving objects by the clients. The server that sends an object to a client on request, may request a receipt. Servers may be configured not to do it. There are conditions in which receipts are not needed, for example, in systems functioning internally within a single organization, or where traffic payment is not implemented, or billing arrangements do not require exact information on transporting a serving objects (e.g. traffic payment is flat or included in other payments).

When a server receives a receipt from a client, it appends to the receipt the contents of the Path header of the served message and digitally signs the result. Then the server sends the receipt to the previous server in the path and saves a copy in its own archive. This procedure is repeated until the receipt reaches the original server.

### Examples of Interaction between Components of the System in the Process of Delivery of a Web Object

### Example 1

### A Server Side Caching Agent Updates an Object Posted Before to the Usenet

We call an object “Usenet-cached” or “news-cached” if it is distributed using this invention. In a preferred case, SSCA must be able to detect events of change of Usenet-cached objects. This is not hard to achieve using such techniques as:

1. SSCA may have a list of all Usenet-cached objects and periodically checks dates and times of their last changes.

2. All Usenet-cached objects are stored in a few dedicated directories, SSCA “knows” these directories and periodically checks dates and times of last changes of all the objects in the directories.

3. If the operating system supports this feature, SSCA subscribes to modification events and receives notification of changes of all the objects.

For the purpose of this example, suppose that we are using the method of using URL as a message Id (described above in 3.9.5.2) and URL of the object is http://www.myserver.com/usenetcached/thatmovie.mpg.

This object has been modified at 9.33.17 on 7.8.2000. The SSCA has detected the fact of the modification using one of the methods above and now has to update the object in the Usenet.

First, it constructs a message-id for the message to be posted. Transformation of the URL to a message-id gives result:

<usenetcached/thatmovie.mpg@www.myserver.com>.

Second, SSCA constructs RUBOI for the modified object. This RUBOI is required to uniquely identify this object in the Usenet. Therefore, we will use its URL and date and time of modification to construct the RUBOI:

<09331707082000-usenetcached/thatmovie.mpg@www.myserver.com>.

Third, SSCA constructs a UBOI for the object from its file size and CRC32 code. Suppose, it is <1234567, 890>.

Fourth, SSUCA constructs a Usenet message with constructed message-id and containing a copy of the object as a binary attachment. If reading access to the object is limited, SSCA places header “X-Access-Protection: read=yes” in the message.

Fifth, SSCA uses XBINUPDATE (or XZIPUPDATE) command to send the new copy of the object to the Usenet.

XBINUPDATE <usenetcached/thatmovie.mpg@www. myserver.com>(<1234567, 890><09331 707082000-usenetcached/thatmovie.mpg@www.myserver.com>) “\r\n.\r\n”

Please note that, by construction, all previous versions of the object were posted with the same message-id, but with different attachments. Consequently, the XBINUPDATE command will cause replacement of previous versions of the object (if any) with the new one.

### Example 2

### A Client Side Caching Agent Retrieves an Object from the Usenet

Client Side Caching Agent sits in the way between Web client and its Internet connection or cache engine. Therefore, all Web requests of the client go through the CSCA and it can detect those of them that request Usenet-cached objects. Suppose it has received a request to retrieve object with URL http://www. myserver.com/usenetcached/thatmovie.mpg.

By the presence of string “usenetcached” in the URL, the agent sees that this object may be found in the Usenet. Therefore, the agent does not pass this request through, but attempts to retrieve the object from the Usenet.

First, the agent transforms the URL in the same way as the SSCA did, to construct the object's message id. The resulting message id is

<usenetcached/thatmovie.mpg@www.myserver.com>.

Second, the agent sends XBINSTAT <usenetcached/thatmovie.mpg@www.myserver.com>command to its local Usenet server, to check whether the message is there and retrieve attachment version information.

Third, if version validation is needed, the agent contacts SSCA of the original server and sends there a validation request with message id, UBOI and RUBOI returned by the XBINSTAT command. SSCA responds whether the version is current and sends access permission, if needed. We do not detail here syntax of the request and format and content of the permission. These are trivial issues. If access is granted, the client receives a digitally signed by the server permission.

Suppose that the version is current. If it is not, the agent acts as if the object were not found. This scenario is described in Example 3.,

Now the agent contacts its local Usenet server to retrieve the message using XBINGET or XZIPGET. Suppose that the message is read-protected and can be accessed only with original server permission. The Usenet server returns code that says, “message access requires permission”.

The agent sends the permission received from the original server to the Usenet server. In exchange, the server returns the requested object. The client sends to the Usenet server a digitally signed receipt.

The Usenet server signs the receipt and sends it upstream using the XBILL command. This procedure is repeated until the receipt reached SSCA of the original server. (Thus, it has to support XBILL command and put itself first in the Path header of the message).

### Example 3

### A Client Side Caching Agent Attempts to Retrieve and Object from the Usenet, but Does Not Find it

Suppose CSCA has received a request to retrieve object with URL http://www.myserver.com/usenetcached/thatmovie.mpg.

By the presence of string “usenetcached” in the URL, the agent sees that this object may be found in the Usenet. Therefore, the agent does not pass this request through, but attempts to retrieve the object from the Usenet.

First, the agent transforms the URL in the same way as the SSCA did, to construct the object's message id. The resulting message id is

<usenetcached/thatmovie.mpg@www.myserver.com>.

Second, the agent contacts its local Usenet server to retrieve the message using XBINGET or XZIPGET. The Usenet server returns code that says, “this message is not found”.

Depending on implementation of the system and configuration, the agent may do one of the following:

1. Just pass the request in order to process it as other requests for objects that are not Usenet-cached. This case is trivial and ends processing of this request by the agent.

2. Attempt to retrieve the object from its original server and post it to the Usenet. This may be more optimal for the system as it would facilitate fast propagation of Usenet—cached objects to remote parts of the Usenet.

The first option is trivial. Suppose that the agent is configured to choose the second option. It contacts the original server (or its SSCA, on behalf of the server) and retrieves the object and receives permission to post it to the Usenet.

The agent returns the object to the client and posts it to the Usenet using XBINUPDATE command. To do that, it constructs the message id, RUBOI and UBOI exactly as it was done by the SSCA in example 1.

Now all billing information is coming to the SSCA via this agent, and it can have part of the reward for retrieving the object and making it available in this remote part of the Usenet. CSCA must support XBILL command and be on-line most of the time. Alternatively, the system may be implemented in such a way, that billing information will be routed to SSCA by the first Usenet server where the message was posted to (in this case, the local server of the client).

We claim:

1. A method of associating an URL with a Web object(s) for transport from a server side (their original server) to a client side via the Usenet or a Usenet-like system, the method including the steps of:
a. Constructing/determining/allocating a URL (Uniform Resource Locator) for the object, and
b. placing the object on the original server in such a way that this URL
1. contains information necessary to find the object in a Usenet server;
2. indicates that the object has been posted to the Usenet and may be found on a Usenet server; and
3. can be used to transparently retrieve the object from its original server.

2. A method of transporting Web object(s) via a Usenet, the method including:
associating a URL with the Web object as claimed in claim 1,
posting the object on the Usenet;
at a client side, intercepting requests for the object, interpreting them and using information extracted, as a result of the interpretation, to locate the object from a Usenet server.

3. A method as claimed in claim 2, further including the step of:
if the object is not found posted on the Usenet , or its version is not current:
retrieving the object from the original server.

4. A method as claimed in claim 3, further including the steps of:
preferably, receiving digitally signed permission to post the object on behalf of the server and to cancel the expired version, if any, and
preferably, transmitting this permission to one or more of Usenet servers along with the object.

5. A URL useful in accordance with the method of claim 1 or 2.

6. A communication system adapted to distribute Web objects from a web host server to a client, the system having:
a Web host server on which the web objects are stored, the web host server being coupled to the WWW,
the coupling between the client, the WWW and web host server enabling bi-directional communication,
the improvement including
providing a first Caching agent intermediate and coupled to the client and WWW and Usenet, and
providing a second Caching agent intermediate and coupled to the WWW and the Usenet and the web host server,
wherein the first and second Caching agents enable communication of objects between the client and the Web host server to be via either the Internet or the Usenet.

7. A system as claimed in claim 6, wherein the first Usenet agent is an application located on the TCP/IP path from the client to the Web cache.

8. A system as claimed in claim 6, wherein the first Usenet agent performs at least some of the following functions:
analyses Web requests containing URLs of required objects,
based on the URL, decides, whether an object has been posted to the Usenet by its original server and thus, may be found in the Usenet,
if the object has not been posted to the Usenet, the first agent passes the request further for normal processing by the Web server or cache engine,
if the object has been posted to the Usenet:
based on its configuration information, the first agent selects one or more available Usenet servers and tries to find the required object on them,
if the object is found, the first agent retrieves it and returns to the client, and/or
if the object is not available, the first agent passes the request for further processing by the original server or a caching engine.

9. A system as claimed in claim 6, wherein the second Usenet agent is located intermediate the web host server and the Internet.

10. A system as claimed in claim 9, wherein the second Usenet agent performs at least some of the following functions:
intercepts requests to the server and identifies those that are requesting Usenet posted objects,
if such a request is found, the second agent cleans up its URL, removing its part that concerns newsgroups or including the required information in the URL and combining it with object placement in such a way, that no further cleaning is necessary,
once cleaned, the URL is passed further for processing by the server or server side cache engine,
tracing events of modification of the server objects that are to be, or have been posted to the Usenet,
if an object has been modified (or created), the second agent cancels its previous versions, if necessary in the Usenet and posts a new digitally signed one, and/or
periodically re-post objects to the Usenet to ensure their availability.

11. A method of creating a URL for use in the Web, the method including the steps of:
providing a first field having information sufficient to locate an object on a web server, and
providing a second field having information sufficient to locate the object on the Usenet.

12. A method as claimed in claim 11, wherein the first field includes an initial URL, and the second field includes a Usenet message ID.

13. A method as claimed in claim 11, wherein the first and second fields are the same and include a Usenet message ID.

14. A method as claimed in claim 13, wherein the message ID is encoded in URL query parameters.

15. A method as claimed in claim 11, wherein the URL is created in a manner where a relatively simple and relatively unambiguous reverse transformation exists.
